(19) United States
(12) Patent Application Publication
(10) Pub. No.: US 2021/0276266 A1
(43) Pub. Date: Sep. 9, 2021

(54) ADDITIVE MANUFACTURING TEMPERATURE CONTROL

(71) Applicant: HEWLETT-PACKARD DEVELOPMENT COMPANY, L.P., Spring, TX (US)

(72) Inventors: Arthur H. Barnes, Vancouver, WA (US); Haseeb Yusef, Vancouver, WA (US); John Geile, Vancouver, WA (US)

(21) Appl. No.: 16/608,448

(22) PCT Filed: Jan. 29, 2018
(86) PCT No.: PCT/US2018/015760

§ 371 Date: Oct. 25, 2019

(51) Int. Cl. B29C 64/393; B29C 64/295; B29C 64/321; B29C 64/153; B33Y 30/00; B33Y 50/02; B33Y 10/00

(52) U.S. Cl. CPC B29C 64/393; B29C 64/295; B29C 64/321; B33Y 10/00; B33Y 30/00; B33Y 50/02; B29C 64/153

(57) ABSTRACT

Some examples include an additive manufacturing machine including a dose plate to receive build material onto, a heating element to selectively heat the build material dispensed on the dose plate, the build material selectively heated in at least two zones, a sensor to detect a temperature of each of the at least two zones, and a controller to control the heating element based on the temperatures of each of the at least two zones.

### BACKGROUND

Additive manufacturing machines produce three dimensional (3D) objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into layers, each defining that part of a layer or layers of build material to be formed into the object.

### BRIEF DESCRIPTION OF THE DRAWINGS

FIG. 1 is a schematic bottom view of an example additive manufacturing machine in accordance with aspects of the present disclosure.

FIG. 2 is a schematic end view of an example additive manufacturing machine in accordance with aspects of the present disclosure.

FIGS. 3A-3B are enlarged schematic bottom and side views of an example dose plate useful in an additive manufacturing machine in accordance with aspects of the present disclosure.

FIGS. 4A-4B are schematic bottom and side views of another example dose plate useful in an additive manufacturing machine in accordance with aspects of the present disclosure.

FIG. 5 is a schematic end view of another example additive manufacturing machine in accordance with aspects of the present disclosure.

FIGS. 6A-6B are schematic side views of example additive manufacturing machines in accordance with aspects of the present disclosure.

FIG. 6C is a schematic top view of a dose plate and a build surface of an example additive manufacturing machine in accordance with aspects of the present disclosure.

FIG. 7 is a flow chart of an example method of additive manufacturing in accordance with aspects of the present disclosure.

FIG. 8 is a graphical representation of an example thermal profile of build material on a dose plate of an additive manufacturing machine in accordance with aspects of the present disclosure.

FIG. 9 is a graphical representation of an example thermal profile of a dose plate of an additive manufacturing machine in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The descriptions and examples provided herein can be applied to various additive manufacturing technologies, environments, and materials to form a three dimensional (3D) object based on data of a 3D object model. Various technologies can differ in the way layers are deposited and fused, or otherwise solidified, to create a build object, as well as in the materials that are employed in each process.

In an example additive manufacturing process, a build material and a printing agent can be deposited and heated in layers to form a build object. An example additive manufacturing technology can dispense a build material and spread the build material onto a build surface to form a layer of build material. The build surface can be a surface of a platen or underlying build layers of build material on a platen within a build chamber, for example. The example additive manufacturing technology can dispense a suitable printing agent in a desired pattern onto the layer of build material and then expose the build material and the printing agent to an energy source, such as a thermal energy source for fusing. Sintering, or full thermal fusing, can be employed to fuse small grains of build material, e.g., powders. Sintering typically involves heating the build material to melt and fuse the particles together to form a solid object.

In some additive manufacturing technologies, the layer of build material may be formed using a roller or a recoater. A printhead may be used to dispense a printing agent, such as a fusing agent or a binder agent, on a formed layer of build material. The recoater and printhead may be carried on a moving carriage system. The moving carriage system may comprise, in different examples, either a single carriage or multiple carriages. A build material dispensing assembly can be mounted to the moving carriage system to dispense and spread build material to form a layer of build material. A printhead can be employed to selectively dispense fusing agent, or another kind of printing agent, and can be mounted to the moving carriage system. A thermal energy source can also be mounted to the carriage system and moved across the build surface. The energy source can generate heat that is absorbed by fusing energy absorbing components of the printing agent to sinter, melt, fuse, or otherwise coalesce the patterned build material. In some examples, the energy source can apply a heating energy, to heat the build material to a pre-fusing temperature, and a fusing energy, to fuse the build material where the printing agent has been applied. Thermal, infrared, or ultraviolet energy can be used, for example, to heat and fuse the material. The patterned build material can solidify and form an object layer, or a cross-section, of a desired build object. The process is repeated layer by layer to complete the 3D build object.

In an example additive manufacturing process using selective laser sintering (SLS) technology, a layer of build material is formed and a thermal heat source, such as a laser, is used to selectively heat and fuse portions of the layer of the build material in a build pattern. With SLS technology, the patterned build material can melt and solidify to form an object layer, or a cross-section, of a desired build object. The process is repeated layer by layer to complete the three dimensional (3D) build object.

Build material can be a powder-based type of build material and the printing agent can be an energy absorbing liquid that can be applied to the build material, for example. Build material can include plastic, ceramic, and metal powders, and powder-like material, for example. In some examples, build material can be formed from, or may include, short fibers that may, for example, have been cut into short lengths from long strands or threads of material. Other types of build materials can also be acceptable.

In one example, the build material dose can be dispensed onto a dose plate prior to being spread onto the build surface. The build material dose can be dispensed onto a dose plate adjacent the build surface to assist with control of the dose. For example, dispensing the build material onto a dose plate prior to the build material being spread onto the build surface can assist with controlling the temperature of the build material prior to the build material being spread onto the build surface. Control of the build material temperature at the dose plate can result in control of variations in thermal profile of the build material layer during spreading of the build material dose over the build surface to mitigate, or control, the effects of convection, conduction or other thermal variations in the build chamber during the build process that can cause over or under fusing of build parts, resulting in part defects and material property variations. It is desirable to monitor and control the build material dose temperature during the build process to reduce thermal variations, resulting in improved material properties and reducing part defects.

The temperature of the build material in the build chamber can be cooler (e.g., have thermal roll off) on the front and back sides of the build chamber, the front and back sides being parallel to the scanning axis, for example. Thermal roll off can occur when cooler temperatures influence warmer temperatures, such as at the edges of heated object layer surrounded by cooler ambient air. In 3D printing, thermal roll off can occur at each build layer in the build chamber. The thermal roll off can be due to several factors such as thermal roll off of the scanning thermic source, conduction of heat into the chamber walls and convective losses due to air currents in the build chamber. Reducing thermal variations, such as thermal roll off on the front and back side areas of the build chamber, can provide a more thermally uniform build area, increase the size of the buildable area, reduce defects in part quality, reduce dimensional inaccuracy, reduce material property defects, and reduce color variation in the build parts.

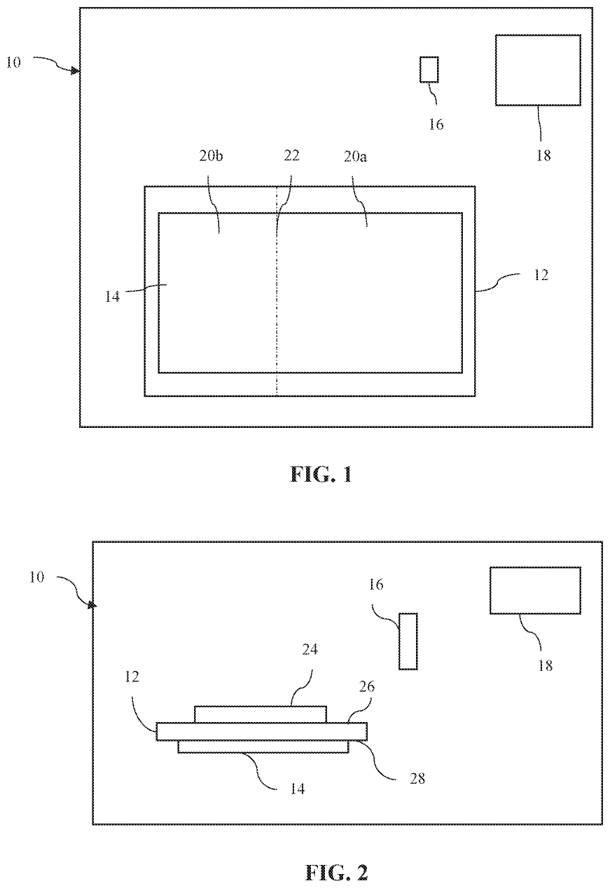

FIG. 1 is a schematic bottom view of an example additive manufacturing machine in accordance with aspects of the present disclosure. The additive manufacturing machine 10 includes a dose plate 12, a heating element 14, a sensor 16, and a controller 18. Heating element 14 can selectively heat build material (see, e.g., FIG. 2) disposed on dose plate 12 in at least two zones 20a . . . x. Sensor 16 can detect a thermal energy or a temperature of each of the at least two zones. For example, sensor 16 can detect a first thermal energy, or a first temperature, in first zone 20a and a second thermal energy, or a second temperature, in second zone 20b. Zones 20a, 20b are distinguished by a dashed line 22 extending between zones 20a, 20b for illustrative purposes. Controller 18 can control heating element 14 based on the thermal energies detected of each of the at least two zones. For example, controller 18 can control heating element 14 based on a first thermal energy detected by sensor 16 in the first zone 20a and a second thermal energy detected by sensor 16 in the second zone 20b.

FIG. 2 is a schematic end view of dose plate 12 useful in the additive manufacturing machine 10 of FIG. 1 in accordance with aspects of the present disclosure. Dose plate 12 includes a top surface 26 and a bottom surface 28. Dose plate 12 can retain build material 24 dispensed by a dispenser (not shown) onto top surface 26 of dose plate 12. In one example, top surface 26 can be substantially planar for dispensing and retaining build material 24. Dose plate 12 can be formed of a thermally conductive material, such as aluminum having a thermal conductivity of greater than 200 Watts per meter Kelvin (W/mK), for example. Dose plate 12 can provide heat conductance from heating element 14, through conductive dose plate 12, and to build material 24 disposed on dose plate 12. In one example, dose plate 12 is formed of aluminum, other metal, or metal alloy. Other conductive materials are also acceptable.

In one example, heating element 14 can be thermally coupled to dose plate 12. In one example, heating element 14 is disposed along bottom surface 28 of dose plate 21. Heating element 14 can selectively heat each zone 12. In one example, heating element 14 can include a resistive heater. Heating element 14 can heat dose plate 12 and build material 24 disposed on dose plate 12 (see, e.g., FIG. 2) to more different thermal energy levels at different areas of dose plate 12 concurrently. For example, heating element 14 can be employed to selectively heat each zone 20a, 20b to a different, independent thermal energy level as described further below.

Sensor 16 can detect a thermal energy or a temperature of each of the at least two zones 20a . . . x at or around dose plate 12. In one example, sensor 16 can be disposed within additive manufacturing machine 10 as appropriate to sense each of first and second thermal energies of first and second zones 20a, 20b, respectively. For example, sensor 16 can be mounted on, or adjacent to, dose plate 12 to sense the temperature of each zone 20a, 20b. One or a plurality of sensors 16 can be employed as appropriate to sense the temperature at each of the at least two zones 20a . . . x. In one example, a separate sensor 16 can be included to sense the temperature of each of the at least two zones 20a . . . x independently. In another example, more than one sensor 16 is included for each of the at least two zones 20a . . . x. In one example, sensor(s) 16 can detect thermal energy or temperature of build material 24 on dose plate 12. In one example, sensor 16 can include an infrared camera. In another example, sensor 16 can include a thermocouple. In one example, sensor 16 can sense a thermal energy or temperature of each of the at least two zones 20a . . . x and communicate the sensed thermal energy or temperature of each of the at least two zones 20a . . . x to controller 18.

Controller 18 can control power to, and thus, energy emitted by heating element 14. Controller 18 can independently adjust energy levels emitted by heating element 14 at each of the at least two zones 20a . . . x based on the thermal energy sensed, or detected by, sensor(s) 16 in each of the at least two zones 20a . . . x. In one example, controller 18 can be employed as a closed loop control system to control the temperature of build material 24 disposed along dose plate 12 at each of the at least two zones 20a . . . x during the build process. In one example, controller 18 can command a target temperature for each of the at least two zones 20a . . . x. Controller 18 can apply power to heating element 14 at each of the at least two zones 20a . . . x to adjust the temperature of each of the at least two zones 20a . . . x to the target temperature for each of the at least two zones 20a . . . x independent of each of the other at least two zones 20a . . . x. Controller 18 can adjust the thermal energy emitted by heating element 14 at each of the at least two zones 20a . . . x independent from the adjacent, or other, zones 20a . . . x based on thermal energy or temperature detected by sensor 16 for each of the at least two zones 20a . . . x, respectively, and transmitted to controller 18. In one example, when target temperature is achieved in the respective zone of the at least two zones 20a . . . x, power to heating element 14 at the respective zone of the at least two zones 20a . . . x can be terminated. In one example, controller 18 controls heating element 14 by switching heating element 14 on-and-off at each of the at least two zones 20a . . . x, respectively, to independently adjust the energy emitted by heating element 14 at each of the at least two zones 20a . . . x. Controller 18 can adjust power level of heating element 14 for each dose of build material 24 disposed on dose plate 12. In one example, controller 18 can adjust power level of heating element 14 based on a dose mass of build material 24 dispensed onto dose plate 12.

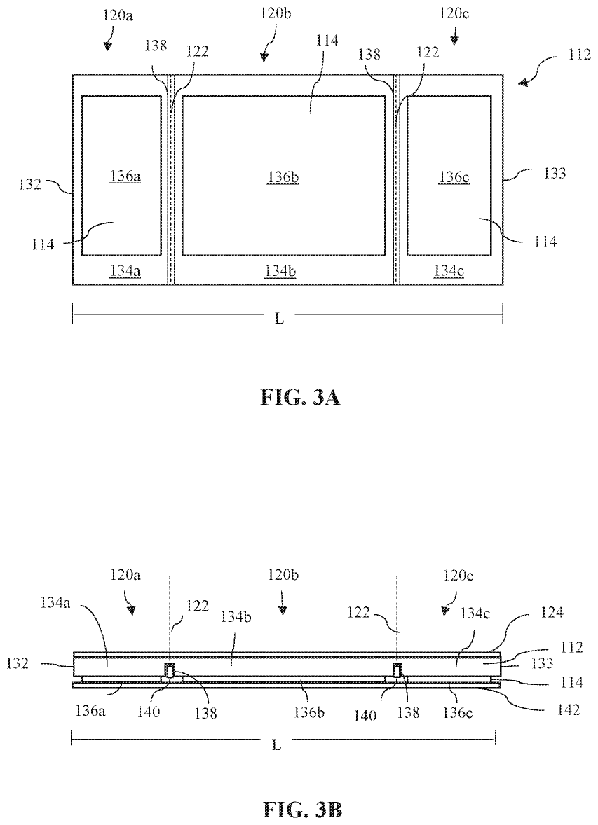

FIGS. 3A-3B are schematic bottom and side views of an example dose plate 112 useful in an additive manufacturing machine in accordance with aspects of the present disclosure. Aspects of dose plate 112 and other elements are similar to those described above. In one example, dose plate 112 can has a length “L” extending between a first edge 132 and a second opposing edge 133. Build material (not shown) can be dispensed across length “L” of dose plate 112. A zone of at least two zones 120a . . . x corresponding to a region of at least two regions 134a . . . x of the dose plate 112 can be distributed in a series along length “L” of dose plate 112. For example, zones 120a, 120b, 120c correspond to regions 134a, 134b, 134c, respectively, as illustrated, and as differentiated by dashed lines 122. In one example, each of the zones 120a-c has a region 134a-c of dose plate 112 and a heating device 136a-c of heating element 114 associated with the respective zone 120a-c. Each of the at least two regions 134a . . . x and associated each of the at least two zones 120a . . . x can be the same or different sizes. In one example, three zones 120a-c are included. In one example, a middle zone 120b can be larger, or has a greater length, than a length of side, or end, zones 120a, 120c. Although three zones 120a, 120b, 120c are illustrated, any number of zones 120 as appropriate to form a desired heat profile, as discussed further below, can be included.

In one example, dose plate 112 can be formed as a single contiguous conductive plate. In one example, dose plate 112 can includes grooves 138, or recesses, between adjacent regions 134 of dose plate 112, extending at least partially through a thickness of dose plate 112 between top surface 126 and bottom surface 128. In one example, grooves 138 extending between adjacent regions 134 of dose plate 112 can aid in control of thermal transfer between regions 134 of respective zones 120. In one example, an insulation 140 can be disposed in grooves 138 to assist with control of thermal transfer between regions 134 and associated zones 120. In one example, insulation 140 is disposed between adjacent regions 134 to inhibit, prevent, or reduce thermal bleed, or cross-over, between adjacent regions 134. Insulation 140 can be formed as strips and disposed within grooves 138, for example. In one example, an insulation layer 142 can also be formed as a sheet and disposed along bottom surface 128 of dose plate 112 and heating element 114 to maintain heat emitted from heating element 114 at or along dose plate 112. Insulation layer 142 can extend partially or fully across heat element 114 and/or bottom surface 128 of dose plate 112. Insulation 140 and insulation layer 142 can be formed of mica, asbestos, ceramic or any other suitable insulation material.

In one example, heating element 114 includes independently controlled portions to independently heat each of the at least two zones 120a . . . x to a different temperature concurrently. In one example, heating element 114 includes individual heating devices 136a . . . x to independently supply heat to each of the at least two regions 134a . . . x of dose plate 112. For example, heating element 114 can include heating devices 136a-c useful to selectively heat each zone 120a-c. In one example, each heating device 136a-c of heating element 114 can be independently associated with and thermally coupled to a specific region 134a-c, or area, of dose plate 112 and, correspondingly, a portion of build material (not shown) disposed onto the respective region 136a-c of dose plate 112. For example, heating element 114 can have first heating device 136a thermally coupled to a first region 134a of dose plate 112 to selectively heat first region 134a to a first thermal energy level or temperature, a second heating device 136b thermally coupled at a second region 134b of dose plate 112 to heat second region 134b of dose plate 112 to a second thermal energy level or temperature, etc. In one example, first and second heating devices 136a, 136b can heat first and second regions 134a, 134b to first and second thermal energy levels (or temperatures), respectively, concurrently.

Although three zones 120a-c are illustrated in FIGS. 3A-3B, any number of zones 120a-x can be included as suitable for the desired thermal profile, as discussed further below. In one example, each of the at least two zones 120a . . . x, and build material disposed in each of the at least two zones 120a . . . x, is capable of being selectively heated by heating device 136a . . . x associated with, and thermally coupled to the respective region of the at least two regions 134a . . . x, independent of adjacent regions of the at least two regions 134a . . . x, respectively. In one example, middle first zone 120b is heated independent of second and third end zones 120a, 120c disposed on opposing sides of first zone 120b. For example, opposing end zones 120a, 120c can be heated to a temperature greater than middle first zone 120b. In one example, second and third end zones 120a, 120c are heated by heating device(s) 136a, 136c to an equivalent temperature to each other. In one example, second and third end zones 120a, 120c are heated by the same heating device 134. In another example, second and third end zones 120a, 120c are heated with separate independent heating devices 134a, 134c. In one example, second and third end zones 120a, 120c are independently heated to different temperatures, each greater than the first middle zone 120b. In one example, a first heating device 136b heats a center region 134b of dose plate 112 and a second heating device 134b heats side regions 136a, 136c disposed on opposing sides of center region 136b. In one example, heating element 114 heats the dose plate 112 to a first temperature in center region 134b and a second temperature in the opposing side regions 134a, 134c on each opposing side of center, or middle, region 134b, wherein the second temperature is greater than the first temperature.

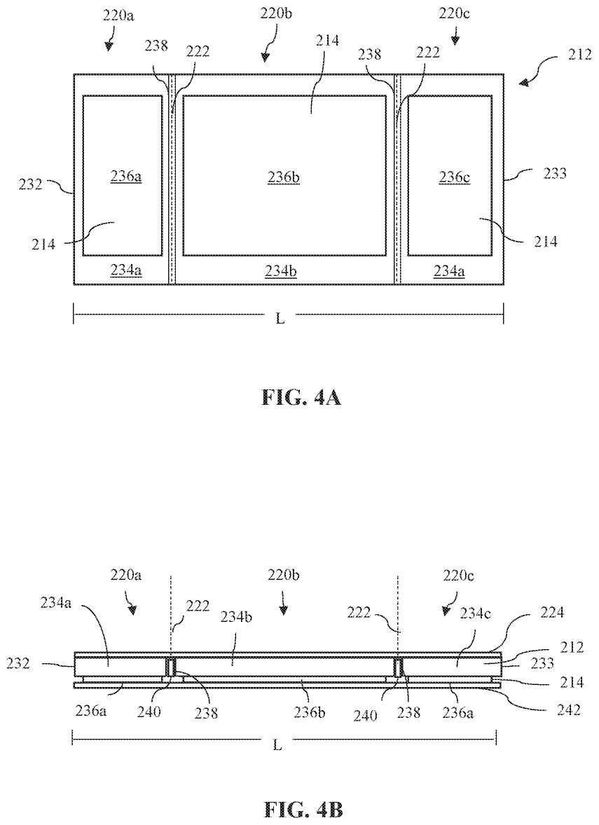

FIGS. 4A-4B are schematic bottom and side views of another example dose plate 212 useful in an additive manufacturing machine in accordance with aspects of the present disclosure. In one example, dose plate 212 is formed of individually formed plates for each region 234a-c in each zone 220a-c. In one example, regions 234a-c of dose plate 212 can be formed of different materials. Regions 234a-c can be assembled in a row to extend between the first and second edges 232, 233. In one example, first region 234b is a center region of dose plate 212 and second region includes side regions 234a, 234c of dose plate 212 disposed on opposing sides of first, center, region 234b. In one example, side regions 234a, 234c are the same size. In one example, first region 234b has a greater length than a length of side regions 234a, 234c. In one example, insulation 240 is disposed between adjacent zoned plates to inhibit or prevent thermal bleed, or cross-over, between adjacent zoned plates. In one example, heating device 234a of heating element 214 provides thermal energy to both side regions 236a, 236c and heating device 234b of heating element 214 provides thermal energy to center region 234b.

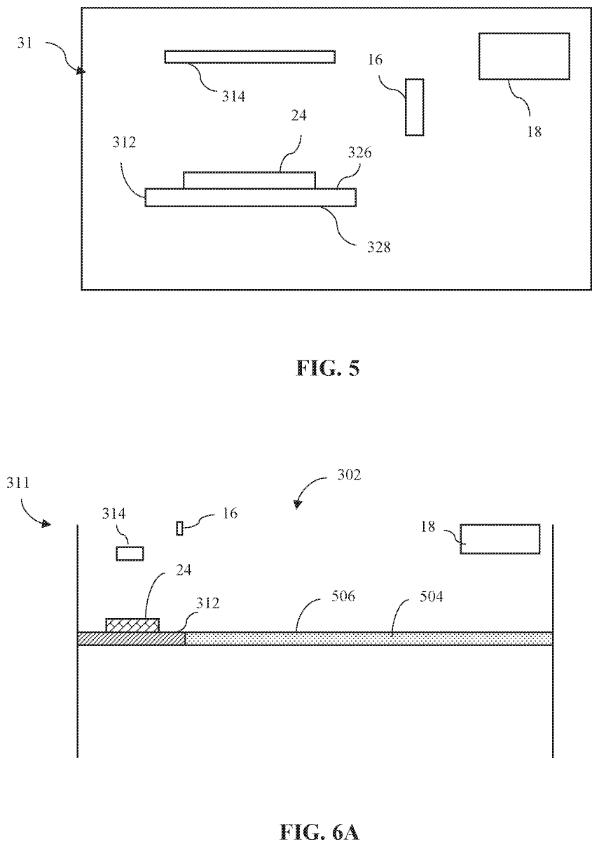

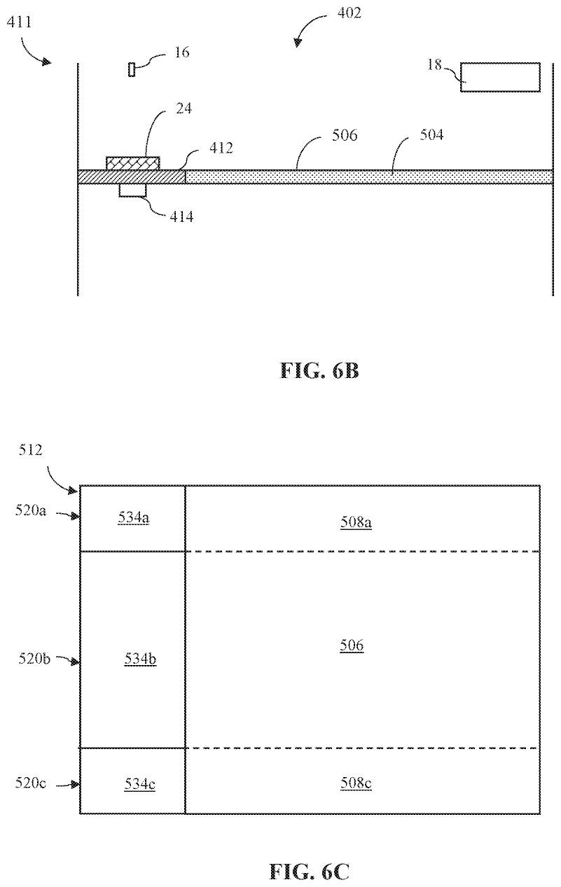

FIG. 5 is a schematic end view of additive manufacturing machine 310 in accordance with aspects of the present disclosure. Additive manufacturing machine 310 includes a dose plate 312, a heating element 314, sensor 16, and controller 18. Heating element 314 can selectively heat dose plate 312 and a build material (not shown) disposed on dose plate 312 in at least two zones (see, e.g., FIG. 6C). Aspects of sensor 16 and controller 18 are discussed above with respect to FIGS. 1 and 2. Sensor 16 can detect a thermal energy or a temperature of each of the at least two zones. Controller 18 can control heating element 314 based on the thermal energies or temperatures detected of each of the at least two zones. Dose plate 312 includes a top surface 326 and a bottom surface 328. Dose plate 312 can retain build material 24 dispensed by a dispenser (not shown) onto top surface 326 of dose plate 312. Heating element 314 can be disposed above top surface 326 to emit thermal energy onto build material 24 and top surface 326 to heat build material 24. In one example, heating element 314 is a heating lamp array including heating devices, such as thermal energy lamps, to independently heat each of the at least two zones.

FIGS. 6A-6A are schematic side views of example additive manufacturing machines in accordance with aspects of the present disclosure. FIG. 6A illustrates an additive manufacturing machine 311 including heating element 314 of FIG. 5. FIG. 6B illustrates an additive manufacturing machine 411 includes heating element 414, similar to heating elements 14,114, and 214 of FIGS. 2, 3A-3B, and 4A-4B. Additive manufacturing machines 311, 411 include build chambers 302, 402, respectively. Build chamber 302, 402 can each include a build area 504 having a build surface 506. Dose plate 312, 412 can be disposed adjacent to build surface 506 in build chamber 302, 402, respectively. Dose plate 312, 412 can provide a top surface to retain build material 24 dispensed by a dispenser (not shown) prior to being spread onto build surface 506 in build chamber 302, 402. Build material 24 can be disposed on dose plate 312, 412 and heated by heating element 314, 414, respectively, prior to being spread onto build surface 306.

Prior to beginning the build process, build material 24 can be dispensed onto dose plate 312,412 at a lower temperature than desired during the build process. For example, dose plate 312, 412 and/or build material 24 can be maintained at room temperature prior to the build process. In one example, heating element 314 can heat dose plate 312 and build material 24 residing on dose plate 312 prior to build material 24 being spread onto build surface 506. In another example, heating element 414 can heat dose plate 412 and dose plate 412 can, in turn, transfer heat from heating element 414 to build material 24 residing on dose plate 412 prior to build material 24 being spread onto build surface 506.

With additional reference to the top view of a dose plate 512 and build surface 506 illustrated in FIG. 6C, thermal energy from heating element 314, 414 illustrated in FIGS. 6A and 6B can be employed to selectively heat each of the at least two zones 520a-c including at least two regions 534a-c of dose plate 312, 412 and build material 24 disposed onto dose plate 312, 412. In one example, zones 520a, 520c are heated to a greater temperature than zone 520b. As build material 24 is moved from dose plate 312, 412 to spread onto build surface 506 (not shown), thermal loss along the zones 520a, 520c extending along sides 508a, 508c of build surface 506 is greater, due to convection and conduction and other factors, than the thermal loss along center zone 520b. With the greater thermal energy applied to build material 24 in regions 534a, 534c of zones 520a, 520c, from heating element 314, 414, build material 24 can have a substantially flat thermal profile on build surface 506, as discussed further below. The build material 24 heated non-uniformly, in zones, can be spread across build surface 506 to form a build material layer on build surface 506 having a substantially uniform temperature.

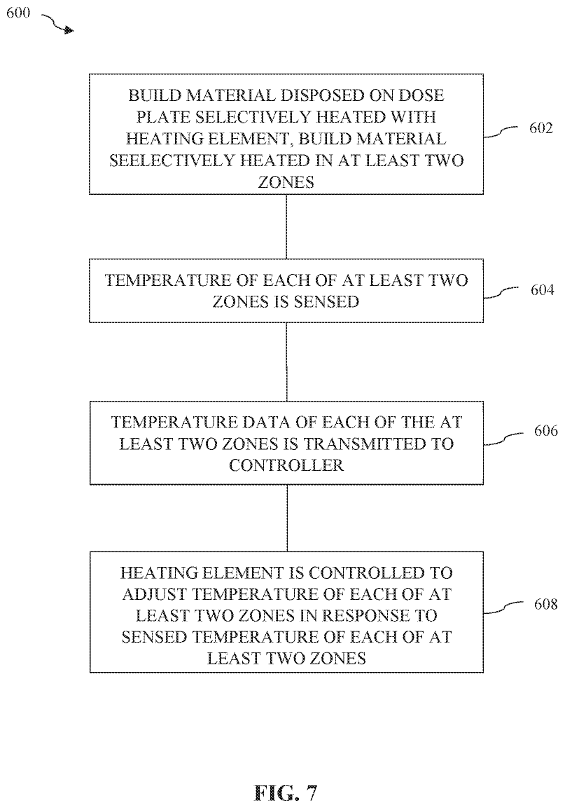

FIG. 7 illustrates a flow chart of an example method 600 of additive manufacturing in accordance with aspects of the present disclosure. At 602, build material on a dose plate is selectively heated with a heating element. The build material is selectively heated in at least two zones. At 604, a temperature of each of at least two zones is sensed. At 606, temperature data of each of the at least two zones is transmitted to a controller. At 608, the heating element is controlled to adjust the temperature of each of the at least two zones in response to the sensed temperature of each of the at least two zones.

FIG. 8 illustrates an example thermal profile of build material disposed on a dose plate of an additive manufacturing machine. Three zones 720a-c are included in this example including a first middle zone 720b and two opposing side zones 720a, 720c. Zones 720a-720c are not heated by a heating element to illustrate the thermal losses occurring due to conduction, convection, and other factors along the side or end zones 720a, 720c. Catch Bin positions are indicated as associated with zones 720a-c. Line 750 indicates the thermal profile across zones 720a-c as sensed, or measured, with an infrared sensor and line 760 indicates the thermal profile of zones 520a-c as sensed, or measured, with a thermal coupler.

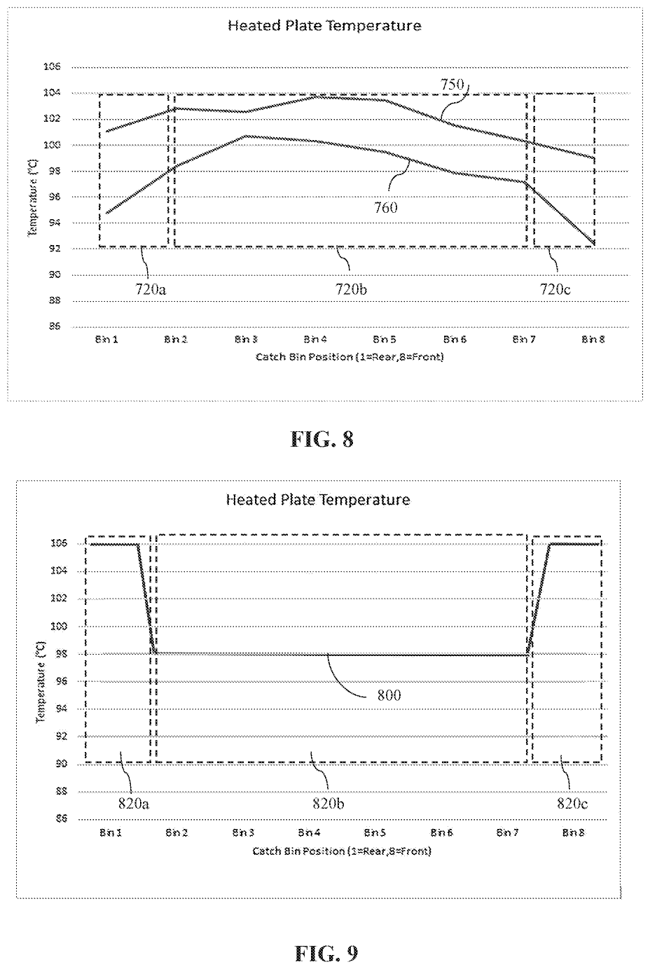

FIG. 9 illustrates an example thermal profile of build material in zones 820a-c of a heated dose plate of an additive manufacturing machine in accordance with aspects of the present disclosure. In this example, line 800 indicates a greater thermal energy applied at opposing end regions of dose plate. As discussed above, the greater temperature at zones 820a, 820c than zone 820b can be distributed across the build surface as build material is spread onto build surface.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An additive manufacturing machine, comprising:
a dose plate to receive a dose of build material onto;
a heating element to selectively heat the build material dispensed on the dose plate, the build material selectively heated in at least two zones;
a sensor to detect a temperature of each of the at least two zones; and
a controller to control the heating element based on the temperatures of each of the at least two zones.

2. The additive manufacturing machine of claim 1, wherein the heating element includes a resistive heater to heat the dose plate.

3. The additive manufacturing machine of claim 1, wherein the heating element includes a heating lamp to heat build material on the dose plate.

4. The additive manufacturing machine of claim 1, wherein a first region of the dose plate corresponds to a first zone of the at least two zones and a second region of the dose plate corresponds to a second zone of the at least two zones, and wherein the second region includes opposing side areas of the dose plate and the first region is disposed between the opposing side areas.

5. The additive manufacturing machine of claim 1, wherein the heating element includes a first heating device to heat a first zone of the at least two zones and a second heating device to heat a second zone of the at least two zones.

6. The additive manufacturing machine of claim 3, wherein the first region of the dose plate is defined from the second region of the dose plate.

7. A method of additive manufacturing, comprising:
selectively heating build material disposed on a dose plate with a heating element, the build material selectively heated in at least two zones;
sensing a temperature of each of at least two zones;
transmitting temperature data of each of the at least two zones to a controller; and
controlling the heating element to adjust the temperature of each of the at least two zones in response to the sensed temperature of each of the at least two zones.

8. The method of claim 7, wherein the heating element is controlled to emit heat at a first temperature in a first zone of the at least two zones less than a second temperature in a second zone of the at least two zones, and wherein the first zone is disposed between side portions of the second zone.

9. The method of claim 7, comprising:
removing the heated build material from the dose plate; and
spreading the heated build material onto a build surface to form a build layer, wherein the heated build material defines a substantially flat thermal profile across the build layer.

10. The method of claim 7, wherein controlling the heating element includes adjusting a first temperature of a first zone of the at least two zones independent of adjusting a second temperature of a first zone of the at least two zones.

11. The method of claim 7, wherein controlling the heating element includes adjusting the temperatures of each of the at least two zones in response to a variation in a mass of the build material on the dose plate.

12. An additive manufacturing machine, comprising:
a plate to receive a dose of build material prior to build material being spread onto a build surface, build material and plate disposed in at least two zones;
a heating element to heat build material on the plate, the heating element to heat the at least two zones independently;
a sensor to sense a temperature of each of the at least two zones; and
a controller to independently control each of the heating element based on the sensed temperature at each of the at least two zones.

13. The additive manufacturing machine of claim 12, the heating element includes at least two heat devices to heat the at least two zones independently.

14. The additive manufacturing machine of claim 13, wherein the at least two heating devices includes a first heat device to heat a first zone, a second heat device to heat a second zone, and a third heat device to heat a third zone, and wherein the controller is to independently control the third heat device based on the sensed thermal energy at the third zone independent of the first and second heat devices.

15. The additive manufacturing machine of claim 12, wherein the heating element includes a heating lamp to heat build material on the plate.
